(19) United States
(12) Patent Application Publication
(10) Pub. No.: US 2025/0257721 A1
(43) Pub. Date: Aug. 14, 2025

(54) SHAPE MEMORY ALLOY TETHER SYSTEM

(71) Applicant: Arizona Board of Regents on Behalf of the University of Arizona, Tucson, AZ (US)

(72) Inventors: Leonard VANCE, Tucson, AZ (US); Jekan THANGAVELAUTHAM, Tucson, AZ (US); David VARGAS, Tucson, AZ (US)

(73) Assignee: Arizona Board of Regents on Behalf of the University of Arizona, Tucson, AZ (US)

(21) Appl. No.: 18/858,053

(22) PCT Filed: Apr. 18, 2023
(86) PCT No.: PCT/US2023/018960

§ 371 Date: Oct. 18, 2024

Related U.S. Application Data
(60) Provisional application No. 63/332,127, filed on Apr. 18, 2022.

(51) Int. Cl. F03G 7/06; B25J 9/10; H02N 10/00

(52) U.S. Cl. CPC F03G 7/0614; B25J 9/1085; H02N 10/00

(57) ABSTRACT

The present disclosure provide a controllably deformable tether to capture a target in a microgravity environment, the tether includes a core, wherein the core is a shape memory material; and a controllable node disposed along the length of the core, the controllable node including node including a node controller and a controllable heating source; wherein the node controller to receive a control signal and control the heating source to cause controllable deformation of the shape memory material in an area around the controllable node.

This application claims the benefit of U.S. Provisional Application Ser. No. 63/332,127, filed Apr. 18, 2022, which is hereby incorporated by reference in its entirety.

### TECHNICAL FIELD

The present application relates generally to microgravity target capture systems and, more particularly, to a shape memory alloy (SMA) tether system.

### BACKGROUND

Smart materials are materials that are manipulated to respond in a controllable and reversible way, modifying some of their properties as a result of external stimuli such as a certain temperature or a certain mechanical stress, among others. One type of smart material is an SMA. An SMA is an alloy that can be deformed when cold but returns to its pre-deformed, i.e., trained, shape when heated. It may also be called memory metal, memory alloy, smart metal, smart alloy, or muscle wire.

A tether is a cord, fixture, or flexible attachment that characteristically anchors something movable to something fixed; it also may be used to connect two movable objects, such as connecting an item being towed to the item towing it. A space tether is used to couple objects together in zero gravity or microgravity environments as they orbit a central body (i.e., Earth).

Space debris, or “space junk,” is becoming an increasingly large problem for space agencies and private companies. Even small pieces of space debris, when moving fast enough, can tear through satellites and human habitats such as the International Space Station.

### SUMMARY

In one illustrative embodiment, an apparatus to capture a target in a microgravity environment comprises: a controller; a core, wherein the core is a shape memory material; one or more heating devices; one or more control nodes; a communications link between the controller and the one or more control nodes; and a cable cover, wherein the cable cover encloses the core, the one or more heating elements, the one or more control nodes, and the communications link; where the core is configured to change shape to envelope a target.

### BRIEF DESCRIPTION OF THE DRAWINGS

Reference should be made to the following detailed description which should be read in conjunction with the following figures, wherein like numerals represent like parts.

FIG. 1A is an illustrative example of the operation of an SMA reactive tether assembly, consistent with the present disclosure.

FIG. 1B is an example of the SMA reactive tether assembly of FIG. 1A, demonstrating the different states of the SMA reactive tether assembly.

FIG. 2 is an illustration of the SMA all-round shape memory effect.

FIG. 3 is an example of one possible configuration of an SMA reactive tether assembly, consistent with the present disclosure.

FIG. 4A is an illustrative example of the states of the FDM control circuit for the SMA reactive tether assembly consistent with the present disclosure.

FIG. 4B is an example of a frequency division multiplexing (FDM) control circuit for the SMA reactive tether assembly consistent with the present disclosure.

FIG. 5A is a diagram illustrating three common earth orbits.

FIG. 5B is a chart illustrating transformation temperatures for three example classes of SMA materials, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Space debris, or “space junk,” is becoming an increasingly large problem for space agencies and private companies. Even small pieces of space debris, when moving fast enough, can tear through satellites and human habitats such as the International Space Station. Currently there is a growing need for efficient methods to capture and deorbit space junk. In addition, since the termination of the space shuttle program, in-orbit servicing has become more difficult. There exists a need for an efficient means to capture targets in a microgravity environment for debris removal and in-orbit servicing. Disclosed herein is an SMA reactive tether assembly that addresses this problem.

The ability of SMAs to exhibit shape memory effect has contributed to the extensive popularity of this material for a wide range of applications. SMAs have this property because of a crystal structure change that occurs when cooling certain specific metals, called a martensitic transformation. The crystal structure found at high temperatures is the parent phase, often referred to austenite, and the phase that results from a martensitic transformation through cooling is called martensite. The shape memory effect is a direct consequence of a reversible transformation between austenite and martensite. The transformation temperature is the temperature at which the phase changes between austenite and martensite. When an SMA is in martensite form at lower temperatures, the metal can easily be deformed into any shape. When the alloy is heated, it goes through transformation from martensite to austenite. In the austenite phase, the memory metal “remembers” the shape it had before it was deformed.

In some embodiments, the shape memory core may replace smart alloys with smart polymers, which present the same shape memory effect. Some examples of SMAs may include, but are not limited to, nickel titanium (NiTi), NiTiCu (NiTi with copper addition), and copper aluminum nickel (CuAlNi). One example of an SMP may include, but is not limited to, carbon-fiber reinforced SMP (FR-SMP).

The SMA tether system is comprised of an assembly containing a high temperature SMA core which is enclosed, or sandwiched, by a series of segments, each segment having one or more joints. In some embodiments, the joints contain heating devices, e.g., heating pads, that may be, for example, on the top of the joint, and cooling devices, e.g., cooling pads, that may be, for example, on the bottom of the joint. In other embodiments, the joints may only have heating pads, and may use ambient cooling in place of the cooling pads. These components are completely enclosed within an insulating material, i.e., a cable cover. In some embodiments, the heating and cooling pad in the joints are controlled by control nodes which may, for example, implement frequency-division multiplexing using analog signals. In other embodiments, any other control mechanism may be used as would be known to a person of skill in the arts. In some embodiments, the system is interconnected via one signal wire and two power wires (power and ground), although other interconnect methods are possible, as would be known by a person of skill in the art.

The SMA reacts to changes in temperature by changing its initial shape into a predetermined, or learned, shape. This SMA effect will be precisely controlled by the system to perform a progressive envelopment of an intended target in a microgravity environment. The system has no dependency on mechanical components, thus avoiding overall system complexity, reducing overall system mass/volume, and keeping power requirements at a minimum. This system exerts small amounts of force on a target (in a microgravity environment) thus avoiding target mishandling in the form of unwanted spinning or potential collisions. In some embodiments, the SMA tether system may include a gripping exterior coating to the cable cover used for the entire system.

This disclosure will allow space-faring platforms, both large and small, to engage in on-orbit servicing and space debris handling activities with greater case and with minimal system adjustments.

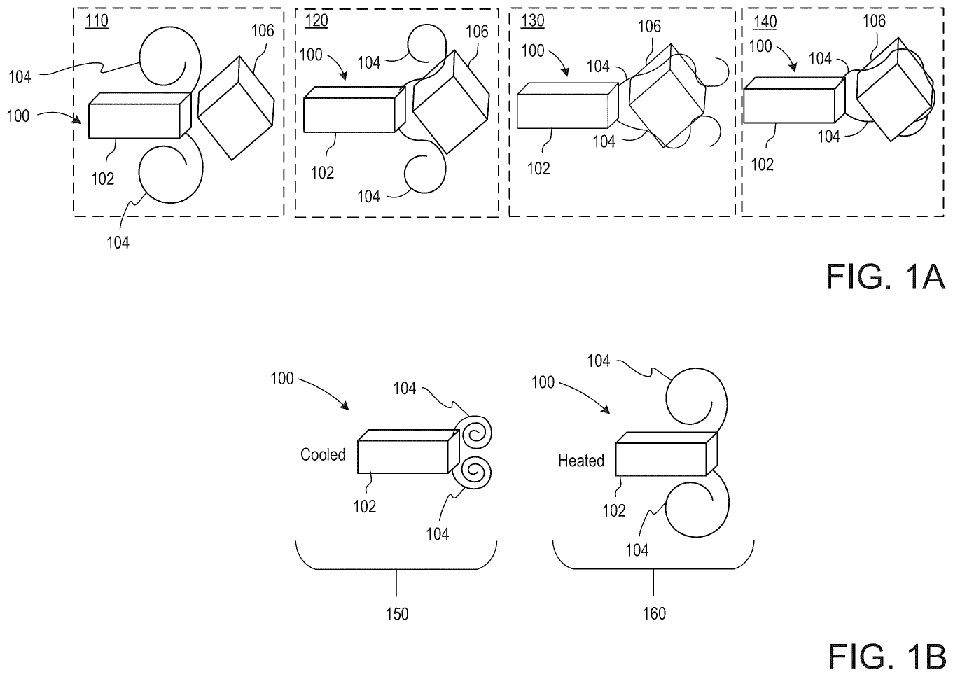

FIG. 1A is an illustrative example of the operation of an SMA reactive tether assembly 100, consistent with the present disclosure. The example of FIG. 1A illustrates the SMA reactive tether assembly 100 capturing target 106 in a microgravity environment by progressively enveloping the target. In the example of FIG. 1A, SMA reactive tether assembly 100 includes controller 102 with arms 104 attached to it. Although the illustrative example of FIG. 1A shows SMA reactive tether assembly 100 including two arms 104, other examples of SMA reactive tether assembly 100 may employ any number of arms may as would be apparent to a person of skill in the art.

In phase 110 of the example of FIG. 1A, the arms 104 are in the stowed configuration, tightly coiled to the controller 102, as the SMA reactive tether assembly 100 approaches the target 106. In phase 120, the controller 102 signals the arms 104 to start to deploy by sending signals to the appropriate joints along each arm 104 to cause the SMA material to progress from the stowed state to the learned state. Phase 130 illustrates the arms 104 continuing to progress towards the learned state, and in this phase the arms 104 are beginning to envelope the target 106. Finally, in phase 140, the arms 104 have fully enveloped the target 106, thereby capturing it.

FIG. 1B is an example of the different states of the SMA reactive tether assembly 100 of FIG. 1A. In the example of FIG. 1B, state 150 illustrates the cooled state, where the arms 104 have been cooled to the martensite state and therefore have retracted into a tightly coiled, or stowed, shape. This tightly coiled shape may be advantageous for packaging for spacecraft deployment to minimize the amount of space required for the SMA reactive tether prior to deployment. In state 160, the arms 104 are heated, causing the arms 104 to convert to the learned state, which is appropriate for capturing the target.

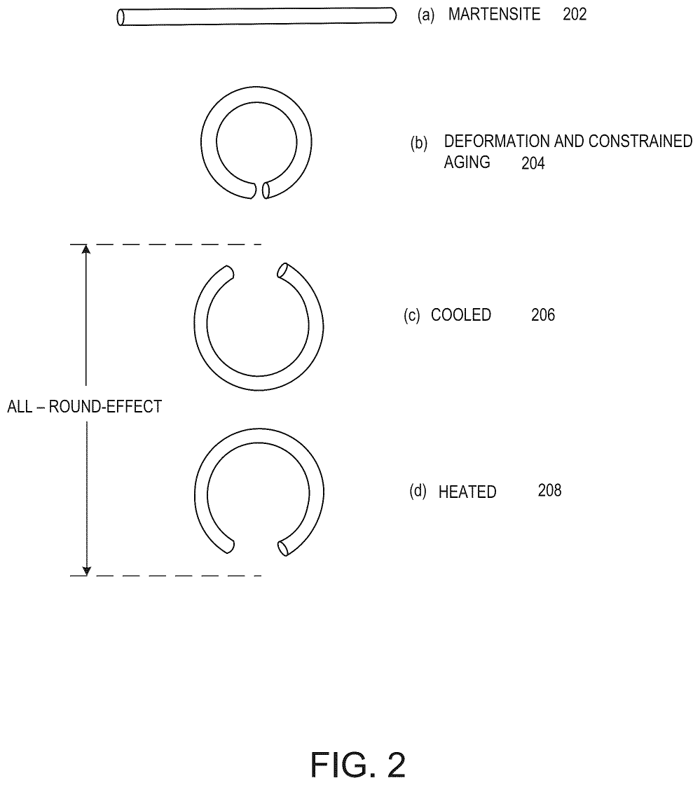

FIG. 2 is an illustration of the SMA all-round shape memory effect. Following aging under stress, SMAs are subject to a two-way shape memory effect known as the all-round shape memory effect, which describes the effect of a dramatic and repeatable shape change from the austenite phase to the martensite phase, with the high and low temperature shapes being exact inverses of each other. Stated alternately, the SMA sample deflects one way when heated and the other way when cooled.

In the illustration of FIG. 2, martensite shape 202 is an SMA in the martensite, or cooled state. After deformation and constrained aging, the SMA “learns” an austenite shape 204 in the austenite phase. Cooled shape 206 and heated shape 208 illustrate the all-round shape memory effect. As illustrated in cooled shape 206 and heated shape 208, the all-round shape memory effect allows the material to change repeatably from one shape in the martensite phase to another shape in the austenite phase. This effect allows the SMA reactive tether assembly to capture an intended target and return to the stowed state once the operation on the target is completed.

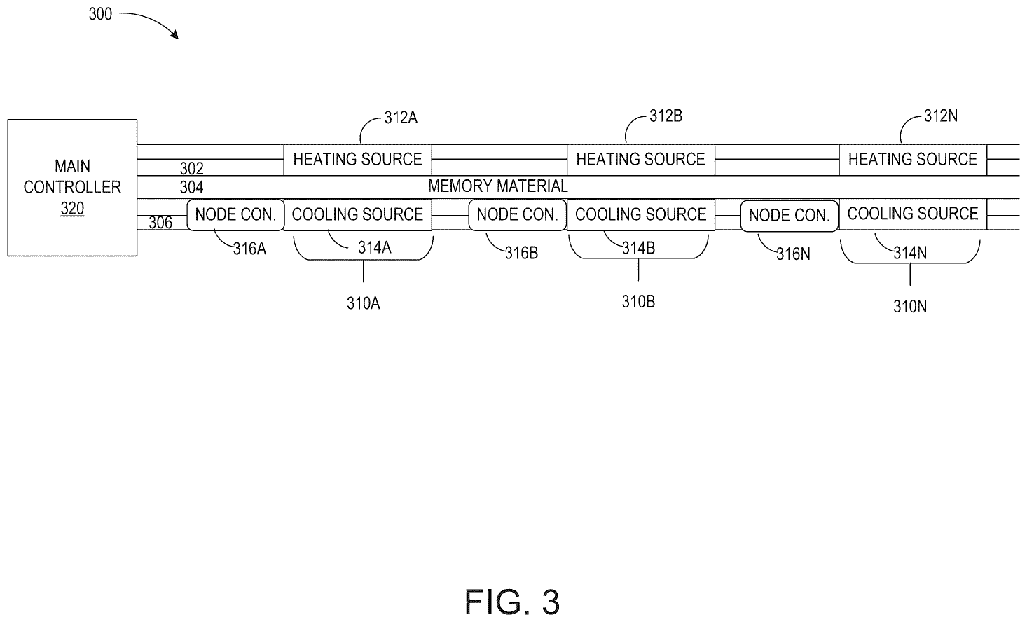

FIG. 3 is an example configuration of SMA reactive tether assembly 300, consistent with the present disclosure. In the cross-sectional view of FIG. 3, SMA reactive tether assembly 300 includes a memory material core 304 surrounded, at least in part, by a conductive layer 302 and an insulating layer 306. One or more controllable nodes, e.g., node 310A, 310B, . . . , 310N are disposed along the length of the tether. Each node, for example node 310A, includes a controllable heating source 312A coupled to the memory material 304 to provide controllable heat to a section of the memory material 304 in the area of the node 310A to enable controllable deformation of the memory material 304 around the node 310A (e.g., to heat each node 310 to the austenite state). Heating sources 312B, . . . , 312N operate in a similar fashion to control deformation in the area of each respective node 310B, . . . , 310N. Each node, for example node 310A, may also include a node controller 316A to control operation of the heating source 312A. In some embodiments, each node controller 316A, 316B, . . . , 316N may be independently controlled (via a main controller, described below) to provide independent deformation control at each node. In some embodiments, nodes 310A, 310B, . . . , 310N may be approximately equally spaced along the length of the tether. In other embodiments, a plurality of nodes 310A, 310B, . . . , 310N may be more concentrated at specific regions of the tether, for example, at the tip region of the tether to provide more accurate control at the end of the tether for grabbing, while other regions of the tether may have fewer nodes.

In some embodiments, one or more nodes 310A, 310B, . . . , 310N may also include one a controllable cooling source, for example controllable cooling source 314A associated with node 310A, to controllable cool node 310A to a martensite state. Cooling sources 314B, . . . , 314N may operate in a similar fashion for respective nodes 310B, . . . , 310N. In some embodiments, the controllable cooling devices 314A, 314B, . . . , 314N include Peltier devices. In other embodiments, the nodes 310A, 310B, . . . , 310N may omit one or more cooling sources, thus allowing ambient cooling to return the tether to the martensite state. Each node 310A, 310B, . . . , 310N is controlled, via respective node controllers 316A, 316B, . . . , 316N to enable the SMA reactive tether assembly 300 to progressively envelope the intended target in a controlled manner. The main controller 320 of the SMA reactive tether assembly 300 accomplishes this by sending signals to instruct each node controller 316A, 316B, . . . , 316N to independently control respective thermal devices (heating sources and/or cooling sources) are to turn on or off, thereby thermally manipulating each node 310A, 310B, . . . , 310N individually. In this way, each node 310A, 310B, . . . , 310N may be independently manipulated for movement upward or downward, e.g., curved. Such control of each node 310A, 310B, . . . , 310N also enables the main controller 320 to cause a change the radius of curvature of SMA reactive tether assembly 300 based on the trained shape to allow for a firmer or a looser grip on the target as needed.

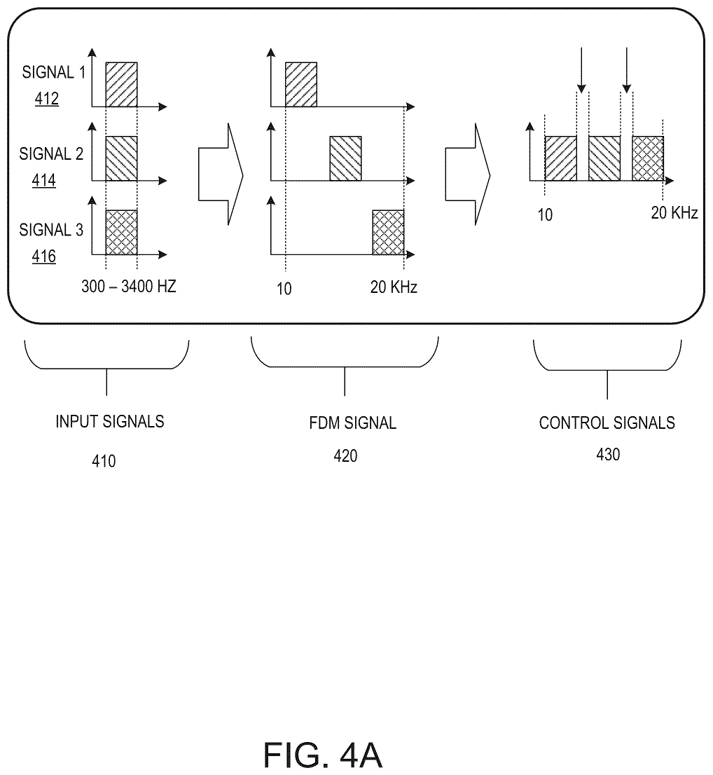

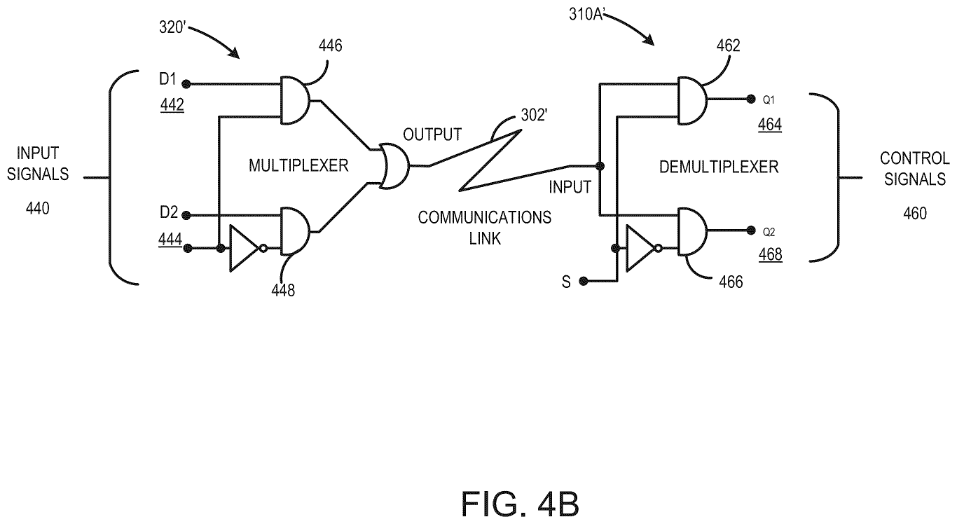

Main controller 320 may operate to transmit command and control signals to each respective node controller 316A, 316B, . . . , 316N, via conductive layer 302, using, for example frequency division multiplexing (FDM). FIG. 4A is an illustrative example of FDM states generated by main controller 320 to control the SMA reactive tether assembly consistent with the present disclosure.

FDM allows for a simple analog electrical system that, effectively and accurately, communicates through a single cable. In the example of FIG. 4A, controller 320 modulates input signal 410 to represent three control signals, signal 1_412, signal 2_414, and signal 3_416, that range in frequency from 300 Hz to 3400 Hz (i.e., 3100 Hz bandwidth per signal). In the FDM circuit, the three signals signal 1_412, signal 2_414, and signal 3_416, are frequency multiplexed into FDM signals 420, where the three 3100 Hz bandwidth signals are spread out over a range from 10 Hz to 20 kHz, and each control signal, signal 1_412, signal 2_414, and signal 3_416 independently controls a respective node controller 316A, 316B, . . . , 316N, to enable a single wire to transmit all three signal simultaneously. When the signal is received at a control node, e.g., c-node 320 of FIG. 3, each node controller 316A, 316B, . . . , 316N will extract the signal in the bandwidth assigned to that control node and ignore the remaining signals on the wire.

Each control signal 412, 414 and 416 may have a signal width and magnitude to control various aspects of the shape memory material (via heating and/or cooling). For example, the width of control signal 214 may be selected to trigger a predetermined on time for the heating source 312A, where a longer pulse width corresponds to a longer on time for the heating source. As another example, the magnitude of control signal 214 may be selected to trigger a predetermined temperature (or temperature range) of the heating source 312A. In a similar fashion, control signals 414 and 416 may operate to control heating/cooling for nodes 312B, 312N, respectively (via node controllers 316B and 316N, respectively).

FIG. 4B illustrates a circuit example of the main controller 320′ and a control node 310A′. the is an example of an FDM control circuit for the SMA reactive tether assembly, consistent with the present disclosure. The example of FIG. 4B is only one example of possible control circuits for the SMA reactive tether assembly. Many other possible control circuit designs for the SMA reactive tether assembly are possible, as would be known to a person of skill in the art.

The example FDM control circuit may implement the states as illustrated in FIG. 4A above. FIG. 4B includes input signals 440, which are multiplexed into FDM signals that are transmitted over communications link 450 to the c-nodes, e.g., c-nodes 320 of FIG. 3, to generate control signals 460. Input signals 440 include input D₀ 442, which feeds into multiplexer 446, and input D₁ 444, which feeds into multiplexer 448. Multiplexer 446 and multiplexer 448 combine the input D₀ 442 and the input D₁ 444 into FDM signals, which are transmitted over communications link 450. When these signals are received at the c-nodes, demultiplexer 462 extracts control signal 464, and demultiplexer 466 extracts control signals 468, based on the frequency assigned to each particular demultiplexer in each particular c-node.

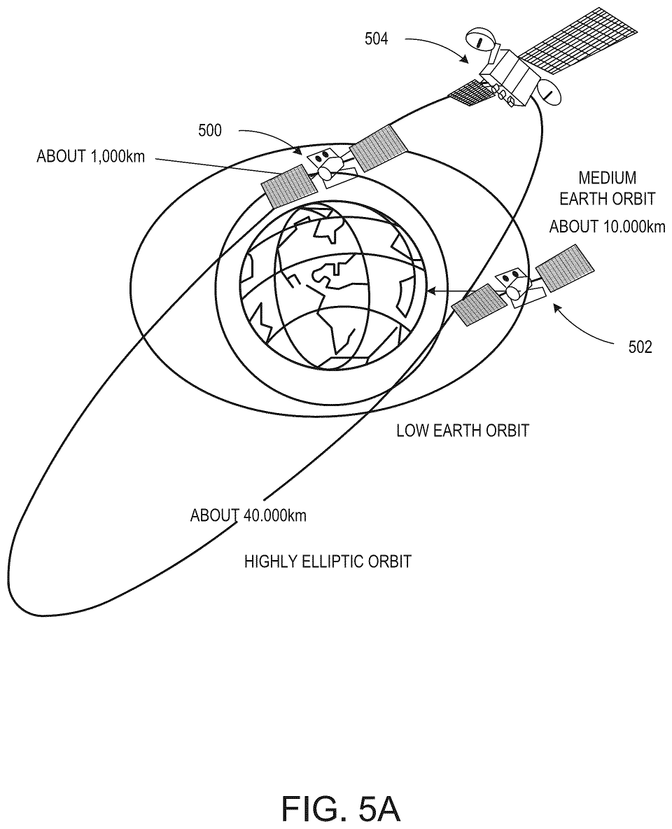

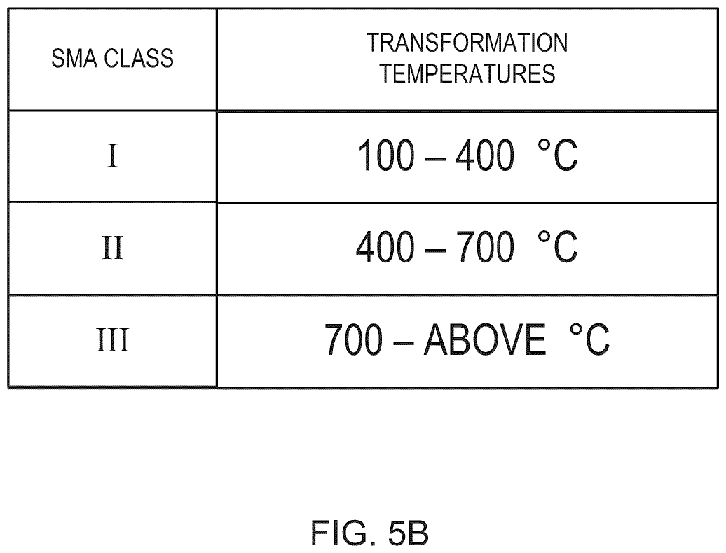

FIG. 5A is a diagram illustrating three common Earth orbits. The three common Earth orbits illustrated in FIG. 5A include the low Earth orbit (LEO), the medium Earth orbit (MEO), and the high Earth orbit (HEO). The LEO is an orbit at or below 1,000 kilometers (km) from the surface of the earth. The satellite 500 shown in FIG. 5A is in an LEO approximately 1,000 km above the surface of the earth. The HEO is an orbit that has an altitude entirely above that of a geosynchronous orbit (35,786 km). The satellite 504 shown in FIG. 5A is in a highly elliptical HEO that reaches apogee about 40,000 km above the surface of the earth. The MEO is an orbit above an LEO but below an HEO. The satellite 502 shown in FIG. 5A is in an MEO approximately 10,000 km above the surface of the earth.

FIG. 5B is a chart illustrating transformation temperatures for three example classes of SMA materials, consistent with the present disclosure. The chart of FIG. 5B demonstrates that there are SMA classes that may work well above standard earth-orbit temperature fluctuations. The main emphasis is that the SMA or SMP to be utilized within the system must have activation temperatures well above earth-orbit temperatures fluctuations to therefore avoid involuntary SMA reactive tether assembly activation. The SMA reactive tether assembly may benefit from the use of higher activation temperatures to take advantage of the speed of heat transfer (via radiation) in space, i.e., the hotter the SMA reactive tether assembly is in comparison to its relative environment, the faster heat will exit the system. This heat transfer phenomena allows the SMA reactive tether assembly to not depend on cooling devices in those embodiments that do not use cooling devices.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A tether system to capture a target in a microgravity environment, the system comprising:
a main controller to generate a control signal; and
a controllably deformable tether, comprising:
a core, wherein the core is a shape memory material; and
a controllable node disposed along the length of the tether, the controllable node including a node controller and a controllable heating source; wherein the node controller to receive the control signal from the main controller and control the heating source to cause controllable deformation of the shape memory material: wherein the controllable node further comprising a controllable cooling source and wherein the node controller to receive the control signal from the main controller and control the cooling source to cause controllable deformation of the shape memory material.

2. The system of claim 1, wherein the core is configured to change shape to envelope a target.

3. The system of claim 1, wherein the shape memory material is composed of a shape memory alloy.

4. The system of claim 1, wherein the shape memory material is composed of a shape memory polymer.

5. (canceled)

6. The system of claim 1 4, wherein the one or more cooling devices are Peltier devices.

7. The system of claim 1, wherein the main controller includes modulation circuitry to generate a modulated control signal and the node controller includes demodulation circuitry to demodulate the modulated control signal and extract commands to control the operation of the heating source.

8. The system of claim 7, wherein the modulation circuitry to generate a frequency division multiplexed (FDM) signal.

9. (canceled)

10. (canceled)

11. A controllably deformable tether to capture a target in a microgravity environment, the tether comprising:
a core, wherein the core is a shape memory material; and
a controllable node disposed along the length of the core, the controllable node including a node controller and a controllable heating source; wherein the node controller to receive a control signal and control the heating source to cause controllable deformation of the shape memory material in an area around the controllable node: wherein the controllable node further comprising a controllable cooling source and wherein the node controller to receive a control signal to control the cooling source to cause controllable deformation of the shape memory material.

12. The tether of claim 11, wherein the core is configured to change shape to envelope a target.

13. The tether of claim 11, wherein the shape memory material is composed of a shape memory alloy.

14. The tether of claim 11, wherein the shape memory material is composed of a shape memory polymer.

15. (canceled)

16. A controllably deformable tether to capture a target in a microgravity environment, the tether comprising:
a core, wherein the core is a shape memory material; and
a plurality of controllable nodes disposed along the length of the core, each controllable node including a node controller and a controllable heating source; wherein each node controller to control a respective heating source to cause controllable deformation of the shape memory material in an area around each controllable node: wherein each controllable node further comprising a controllable cooling source and wherein the node controller to control the cooling source to cause controllable deformation of the shape memory material in an area around each controllable node.

17. The tether of claim 16, wherein the core is configured to change shape to envelope a target.

18. The tether of claim 16, wherein the shape memory material is composed of a shape memory alloy.

19. The tether of claim 16, wherein the shape memory material is composed of a shape memory polymer.

20. The tether of claim 16, wherein a first plurality of the controllable nodes being concentrated in a selected region of core, and a second plurality of the controllable nodes being disposed at approximately equal spacing in other regions of the core.

21. The tether of claim 16, wherein the plurality of the controllable nodes being disposed at approximately equal spacing in other regions of the core.
